(19) United States
(12) Patent Application Publication
(10) Pub. No.: US 2021/0231512 A1
(43) Pub. Date: Jul. 29, 2021

(54) GAS PRESSURE MEASUREMENT DEVICE

(71) Applicant: ECOLE POLYTECHNIQUE FEDERALE DE LAUSANNE (EPFL), Lausanne (CH)

(72) Inventors: Ian ROUSSEAU, Lausanne (CH); Pirouz SOHI, Preverenges (CH)

(21) Appl. No.: 17/053,592

(22) PCT Filed: May 7, 2019
(86) PCT No.: PCT/IB2019/053730

§ 371 Date: Nov. 6, 2020

(30) Foreign Application Priority Data
May 8, 2018 (IB) PCT/IB2018/053177

(51) Int. Cl. G01L 1/24

(52) U.S. Cl. CPC G01L 1/24

(57) ABSTRACT

The present invention concerns vacuum pressure gauge or gas pressure measurement device comprising a polar semiconductor structure, at least one light source for illuminating a surface of the polar semiconductor structure, measurement means configured to measure a value representing a gas adsorption rate or a change in gas adsorption rate on the surface of the polar semiconductor structure, comparison means configured to compare said measured value with at least one predetermined setpoint value representing a balance between photoinduced desorption and gas adsorption on the surface of the polar semiconductor structure and control means configured to change an optical output power of the light source to match or substantially match said measured value with said setpoint value.

### CROSS-REFERENCE TO RELATED APPLICATIONS

The present application claims priority to international patent application number PCT/IB2018/053177 filed on May 8, 2018, the entire contents thereof being herewith incorporated by reference.

### FIELD OF THE INVENTION

The present invention concerns a vacuum pressure gauge or a gas pressure measurement device. The present invention also concerns a vacuum pressure measurement method or a gas pressure measurement method.

### BACKGROUND

The first gas sensor based on a conventional silicon FET was invented by I. Lundström in 1975 [1]. Since then, various improvements have led to the suspended gate concept, whereby a metal gate coated with gas-sensitive layer is suspended above the FET [2]. Such devices are currently sold as hydrogen sniffers in vacuum leak detection systems [24]. With the commercialization of blue light-emitting diodes and high-mobility transistors based on III-nitride materials in the 1990s, the gas FET device concept was transposed to III-nitride semiconductors in the early 2000s, mainly by Stephen Pearton's research group at the University of Florida, Martin Stutzmann's research group at TU-Munich, and Martin Eickhoff's research group at the University of Giessen. Several scientific publications [3-7, references herein] in addition to patents and patent applications [8-13] were filed in the early 2000s for gas and liquid sensing based on open or gated 2DEG FETs with various gate materials and surface functionalization [14]. Interest in the area appears to have faded by the mid- to late-2000s.

In the past ten years, several scientific articles were published about photoinduced gas desorption in III-nitride materials, particularly GaN [15-19]. Similar physical phenomena were studied in CdS, CdSe, and ZnO in the 1970s [20,21].

However, conventional semiconductors for FET sensors, such as silicon, gallium arsenide, and silicon carbide, do not exhibit photoinduced gas desorption phenomena to the best of the Inventors knowledge. In studies of polar semiconductors, the change in the surface charge is typically measured by the Kelvin probe technique, whereby a vibrating capacitor is placed in close physical proximity to the surface. Thus, such an apparatus is impractical in a commercial application due to cost, complexity, and robustness.

In contrast, the method and device of the present disclosure concern a method and device of vacuum pressure measurement by balancing adsorption and desorption rates, on for example, III-nitride semiconductor surfaces using optically generated carriers, for example, optically generated free carriers generated in the bulk semiconductor.

The method and device of the present disclosure represents an important departure from prior patents [21-23], where a single target gas species may be selectively desorbed from the surface by illumination using photons with a sub-bulk band gap energy corresponding to that target gas species, e.g. not using charges generated in the bulk material.

The Inventors attempted to desorb gases using sub-bulk band gap photons, and found that such irradiation does not cause desorption in III-nitride materials. Furthermore, the prior art neither discloses gas pressure quantification [21-23], especially in the high and ultrahigh vacuum regime, nor solves practical issues of slow time response [17], nor presents a reduction to practice based on a compact, affordable monolithic measurement device [17,21-23].

The device of the present disclosure including, for example, a III-nitride semiconductor device and the method presented herein constitute a novel means for the transduction of high vacuum pressure in manufacturing and research equipment.

High vacuum gauges are used in thin film coating, semiconductor manufacturing, and R&D industries to regulate the environment inside a machine during material deposition and/or characterization. The existing technologies are essentially vacuum tubes, where a thermionic or cold cathode current between two electrodes depends on the local gas pressure and composition. Such gauges exhibit many shortcomings, including finite lifetime due to filament burnout, periodic maintenance due to material sputtering, high power consumption, gas-dependent correction factors, poor (up to 30%) relative accuracy, large size, and high cost.

### SUMMARY OF THE INVENTION

The present invention addresses the above-mentioned limitations by providing a device comprising:
a polar semiconductor structure;
at least one light source for illuminating a surface of the polar semiconductor structure;
measurement means for measuring a value representing a gas adsorption rate or a change in gas adsorption rate on a surface of the polar semiconductor structure;
comparison means for comparing said measured value with at least one predetermined setpoint value representing a balance between photoinduced desorption and gas adsorption on the surface of the polar semiconductor structure; and
control means for changing an optical output power of the light source to substantially match said measured value with said setpoint value.

According to an aspect of the present disclosure, the vacuum pressure gauge or gas pressure measurement device, further includes:
determination means configured to determine or measure the optical output power or the change in optical output power of the light source at which said measured value matches or substantially matches said setpoint value;
storage means including at least one data set associating, for the at least one predetermined setpoint value, (i) a plurality of pressure values with (ii) optical output power values or changes in optical output power values of the light source; and
calculation means configured to determine a pressure value based on said at least one data set and said measured or determined optical output power of the light source or said measured or determined change in optical output power values of the light source.

The present disclosure also provides a pressure measurement method including the steps of:
providing a polar semiconductor structure;
measuring a value representing a gas adsorption rate or a change in gas adsorption rate on a surface of the polar semiconductor structure;
comparing said measured value with at least one predetermined setpoint value representing a balance between photoinduced desorption and gas adsorption on the surface of the polar semiconductor structure; and
changing an optical output power of a light source illuminating the polar semiconductor structure to substantially match said measured value with said setpoint value.

According to an aspect of the present disclosure, the method includes the steps of:
determining or measuring the optical output power or the change in optical output power of the light source at which said measured value matches or substantially matches said setpoint value;
providing at least one data set associating, for the at least one predetermined setpoint value, (i) a plurality of pressure values with (ii) optical output power values or changes in optical output power values of the light source; and
determining a pressure value based on said at least one data set and said measured or determined optical output power of the light source or said measured or determined change in optical output power values of the light source.

Other advantageous features can be found in the dependent claims.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIGS. 1A and 1B show an exemplary prototype of part of a gas pressure measurement device according to the present disclosure. FIG. 1a shows an exemplary 8×12 mm² chip that is bonded in a chip carrier. Each chip contains four gauges, whose active area (central square region shown in FIG. 1B) ranges, for example, between 2.5 and 10 μm². External light source and control loop are not shown. FIG. 1C is a schematic of an exemplary embodiment of the device of the present disclosure.

FIGS. 2A and 2B show exemplary Energy band diagrams of an exemplary pressure gauge of the present disclosure in the dark (2A) and following illumination (2B). Illumination with above band gap photons triggers desorption of the adsorbed gas species. The desorption changes the surface charge or band bending (ϕ_{b}), which is inversely related to a two-dimensional electron gas (2DEG) sheet resistance, n_{2D}. These diagrams correspond to the exemplary case of a n⁺⁺-doped and/or thick near-surface layer.

FIG. 3 shows a flow chart showing a proportional-integral-derivative (PID) control loop combined with a vacuum calibration curve to create a vacuum pressure gauge according to the present disclosure. The setpoint is, for example, a value of the sheet resistance. By analyzing the difference between the measured and set point sheet resistances, the light source intensity is dynamically modified. After evaluating the change in intensity, the total light source intensity is converted to a pressure using a calibration curve or model, such as the exemplary one shown in FIG. 4. Depending on the vacuum regime, multiple sheet resistance setpoints may be desirable. For instance, a lower sheet resistance may be desirable at high vacuum levels, since the illumination intensity required to balance adsorption and desorption decreases with pressure.

FIG. 4A shows exemplary calibration curves for an exemplary prototype gauge of the present disclosure showing multiple sheet resistance (Rₛ) setpoints follow a simple power law response spanning six orders of magnitude. The pressure range was limited on both ends by the experimental apparatus. FIG. 4B shows calibration curves in O₂ and N₂ atmospheres for Rₛ=1.2 Id/FIGS. 5A and 5B show cross-sections of (a) simple and (b) complex exemplary embodiments of the pressure gauge of the present disclosure. First, the III-nitride crystal is grown, for example, by metal-organic vapor phase epitaxy. A device is then defined by etching an isolation trench around the gauge. Two or four metal contact electrodes are, for example, deposited to measure a 2DEG sheet resistance and a passivation layer ensures that only the gauge surface is exposed to the surrounding environment.

Additional elements of the complex embodiment include one or more of, for example, a thin film heater, a suspended gate electrode, and a monolithically integrated light source (for example, multiple InGaN/GaN quantum wells (MQW) and doped GaN layers) grown underneath the gauge instead of integrated externally.

FIG. 6 is an exemplary simple process flow showing how to fabricate the device of the present disclosure.

FIG. 7 shows a flow chart explaining how a measured resistance (R_{12,34}) is translated to a Schottky barrier height ϕ_{b} and eventually pressure.

FIG. 8A shows temperature dependent sheet resistance measurements conducted in a Hall effect apparatus, which can separate the temperature dependence into 2DEG sheet density (left axis) and mobility (right axis) contributions as shown in FIG. 8B.

FIG. 9 is a Band diagram schematic showing the Fermi level (E_{F}) pinned by a high density of states (DOS) localized at the surface with energy within the bulk energy gap (SS). The depletion of the charge near the surface forms a space charge region of width L_{sc}, which, via Poisson's equation, results in an electrostatic field of several kV/cm and Schottky potential barrier (ϕ_{b}) for electrons to reach the surface. CB and VB denote the conduction band energy minimum and valence band energy maximum, respectively.

FIG. 10A shows exemplary epitaxial layers of a semiconductor device of the present disclosure and FIG. 10B shows a Schrödinger-Poisson numerical simulation of a band diagram in thermal equilibrium for a thin and undoped cap layer.

In FIG. 11, the solid line shows the charge model relating a 2DEG density (n_{2D}) to a Schottky barrier height (ϕ_{b}). The two measured data points represent ϕ_{b} in thermal equilibrium in the dark and are in excellent agreement with measured values for bulk GaN layers [15,17].

FIG. 12A shows a time response of a gauge of the present disclosure after turning on a UV LED (mW/cm² intensity) at room temperature in ambient atmosphere. FIG. 12B shows signal recovery after turning off the UV LED at room temperature in ambient atmosphere. The time response for t>t₂ follows a logarithmic time dependence due to the system dynamics.

FIG. 13A shows a time-dependent pressure dependence and FIG. 13B shows temperature dependence of the logarithmic recovery time constant (τ₁) in O₂ (open) and N₂ (solid).

FIGS. 14A to 14D shows different measurement means for measuring a value representing a Schottky barrier height of the of a polar semiconductor structure.

Herein, identical reference numerals are used, where possible, to designate identical elements that are common to the Figures.

### DETAILED DESCRIPTION OF SEVERAL EMBODIMENTS

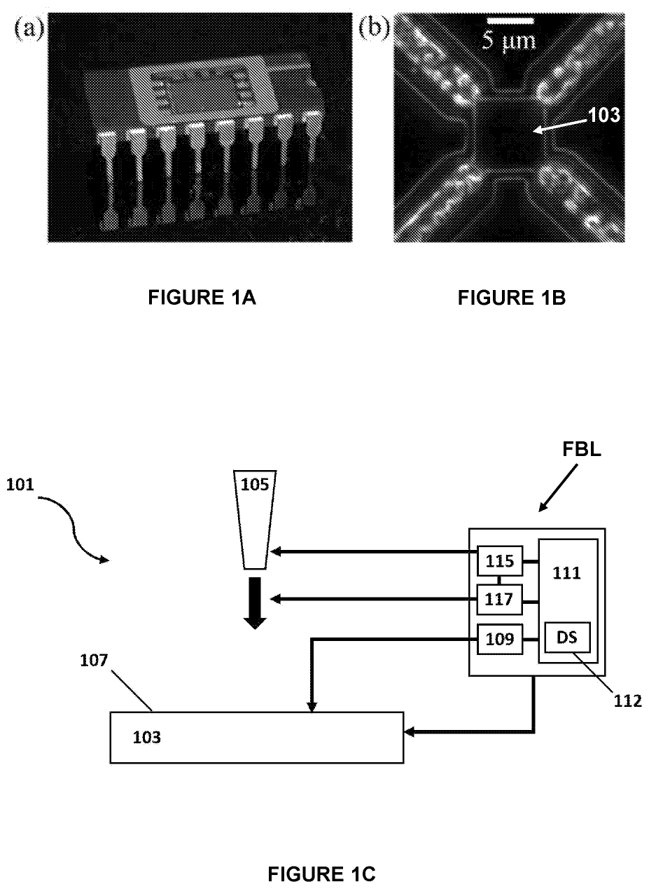

FIG. 1C shows a schematic of an exemplary embodiment of a gas pressure measurement device or vacuum pressure gauge 101 of the present disclosure.

The vacuum pressure gauge or gas pressure measurement device 101 includes at least one polar semiconductor structure 103, at least one light source 105 for illuminating a surface 107 of the polar semiconductor structure 103, and measurement means (or gas measurement means) 109 configured to measure a value MV representing a gas adsorption rate on the surface 107 of the polar semiconductor structure 103 or a change in a gas adsorption rate on the surface 107 of the polar semiconductor structure 103.

The gas pressure measurement device 101 may further include comparison means 111, 112 for comparing the measured value MV representing the gas adsorption rate or change in a gas adsorption rate with at least one predetermined setpoint value VSP. The setpoint value VSP represents a balance between (i) photoinduced desorption of a gas from the surface 107 of the polar semiconductor structure 103 and (ii) gas adsorption onto the surface 107 of the polar semiconductor structure 103.

The gas pressure measurement device 101 may further include control means or a controller 115 configured to change an optical output power of the light source 105 so as to (substantially) match the measured value MV with the setpoint value VSP.

Substantially matching means that the difference between the values is <1% or <5% or <10% of the setpoint value VSP. The particular mode of operation of the device 101 desired will determine the difference value to be used.

The gas pressure measurement device 101 can further comprise determination means 117 configured to determine or measure the optical output power or the change in optical output power OP of the light source 105 at which the measured value MV substantially matches the setpoint value VSP.

The gas pressure measurement device 101 can further comprise storage means 112 including at least one data set DS associating, for the at least one predetermined setpoint value VSP, (i) a plurality of pressure values with (ii) optical output power values or changes in optical output power values of the light source 105.

The data set or sets DS can be included, for example, in a look-up table stored in the storage means 112. The at least one data set DS can include data concerning a power law response of pressure values PV and optical output power of the light source 105 for one or more setpoint values VSP. The one or more setpoint values VSP may consist of or comprise, for example, setpoint surface charge values or setpoint sheet resistance values.

The gas pressure measurement device 101 can further comprise a calculator or calculation means 111.

The calculator or calculation means 111 is, for example, configured to determine a pressure value PV based on the at least one data set DS and (i) the measured or determined optical output power value OP of the light source 105 or (ii) the measured or determined change in optical output power value OP of the light source 105.

The measurement means 109 configured to measure a value MV representing a gas adsorption rate or a change in a gas adsorption rate on the surface 107 can comprise, for example, a surface charge or sheet resistance measurement device where the measured value MV corresponds to a measured sheet resistance value measured on the gas exposed surface 107.

The sheet resistance device can include, for example, a plurality of probes or contact points for contacting the surface 107, a current source and a potential measurement apparatus such as a voltmeter. A sheet resistance value is determined using a measured voltage value measured between two probes in contact with the surface 107 when a constant current is applied to two other probes also contacting the surface 107.

Alternatively, the sheet resistance can be measured using a two-point probe measurement where, for example, a resistance is measured with probes close together and far apart and the sheet resistance being determined from the difference between these two measured resistances.

The measuring means 109 can be configured, for example, to measure a sheet resistance value of the polar semiconductor structure 103 via, for example, a two-electrode configuration, a three-electrode configuration or a four-electrode configuration.

The measurement of a value MV representing a gas adsorption rate or a change in a gas adsorption rate on the surface 107 can be carried in many different ways and is not limited to the above-mentioned sheet resistance measurement.

The measurement of a value representing a gas adsorption rate or change in a gas adsorption rate on a surface 107 of the polar semiconductor structure 103 corresponds to (or represents) a measurement of the Schottky barrier height (or equivalently surface Fermi level position) in the polar semiconductor structure 103. The four-point probe measurement of a sheet resistance (for example, a 2DEG sheet resistance) is one of several means for performing this measurement of the Schottky barrier height.

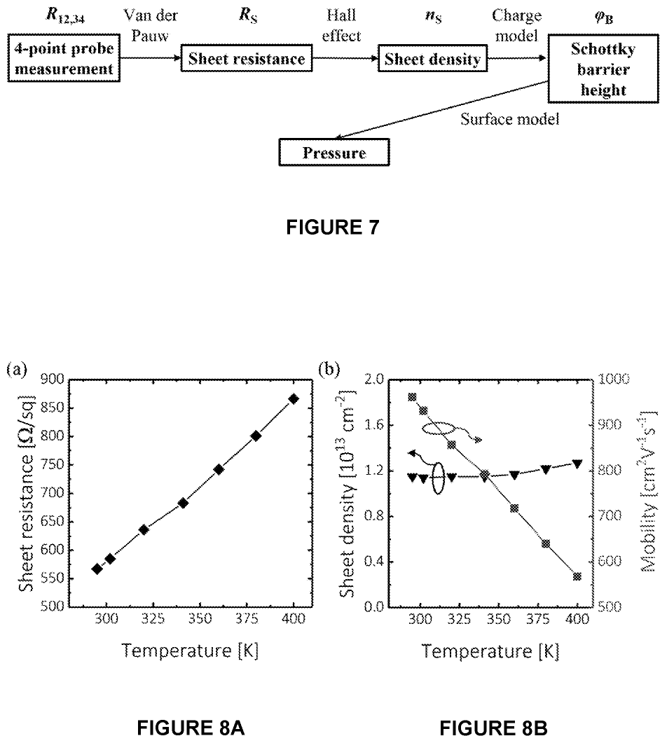

FIG. 7 explains how one moves from a measured resistance value to Schottky barrier height and then to a pressure value, but other measurement techniques also allow one to arrive at the Schottky barrier height. These include, the following exemplary embodiments, but are not limited to these:

Transistor Threshold Shift

Measuring a shift of a threshold voltage in an air-gapped open gate FET structure, that may or may not include an epitaxial 2DEG.

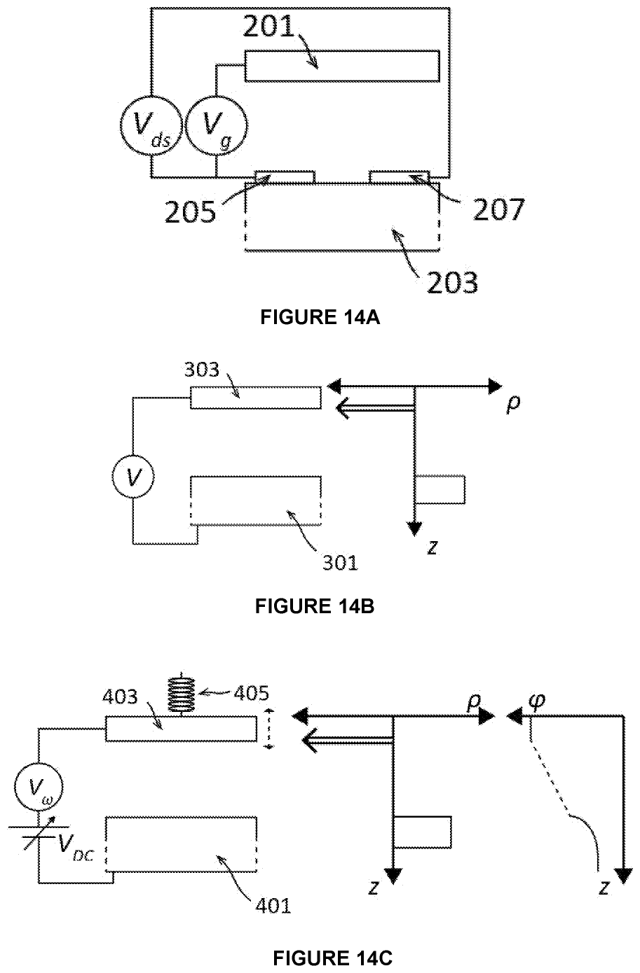

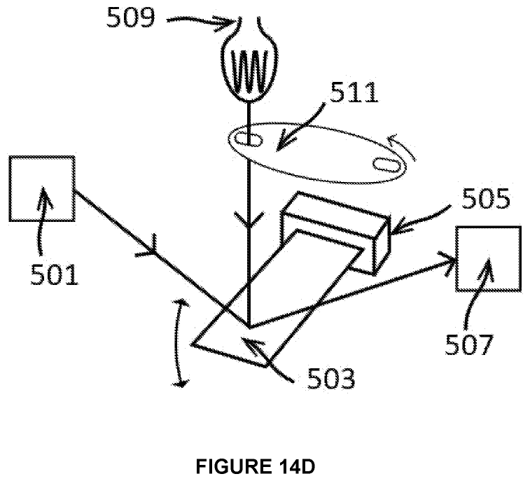

A field-effect transistor can, for example, be constructed with an air-gapped gate electrode 201 suspended above a bulk doped semiconductor 203 (polar semiconductor structure) as shown for example in FIG. 14A. As known in the state-of-the-art, a gate voltage V_{g} can modulate the conductance between drain 205 and source 207 electrodes by several orders of magnitude by creating a conduction channel at the semiconductor 203, the so-called deep inversion regime. Threshold voltage (V_{g}=Vₜ) occurs when the drain-source voltage is extrapolated to zero on a linear scale at low drain-source bias (V_{g}<<V_{ds}). A change in the surface potential (Δφ_{b}) results in a Vₜ shift following [33],

$$Δ {V}_{t} = \frac{Δ {ϕ}_{b}}{q} + \frac{\sqrt{2 {ɛ}_{0} {ɛ}_{r}^{GaN} {N}_{d}}}{{C}_{0}} ( \sqrt{{ϕ}_{b 0} + Δ {ϕ}_{b}} - \sqrt{{ϕ}_{b 0}} ) ,$$

where C₀=ε₀/d is the capacitance per unit area of the metal-air junction, N_{d} is the ionized donor concentration, q is the fundamental charge, and ε₀εᵣ^{GaN} is the dielectric permittivity of the semiconductor.

Capacitance Measurement

A capacitance measurement of a metal-insulator (air)-semiconductor, with an air-gapped metal electrode and, for example, a bulk GaN layer.

In an air-gapped metal-insulator-semiconductor (MIS) capacitor, a depletion region forms inside a bulk semiconductor 301 (polar semiconductor structure) to compensate the electrostatic charge on the metal capacitor plate 303. FIG. 14B shows a schema of the device and associated electrostatic charge profile. The width of the space charge region changes with the applied voltage, which modifies the MIS device's capacitance following [33],

$${C}_{d}^{- 1} = {C}_{0}^{- 1} + \sqrt{\frac{2 ( {ϕ}_{b} - qV - 2 {k}_{B} T )}{{q}^{2} {ɛ}_{0} {ɛ}_{r}^{GaN} {N}_{d}}} ,$$

where V is the applied voltage across the capacitor, k_{B} is the Boltzmann constant, and the rest of the variables are defined above.

Kelvin Probe

Using the Kelvin probe technique with a vibrating top plate capacitor. The Kelvin probe technique is the standard technique for measuring the work function difference between two surfaces [34]. The structure for the Kelvin probe measurement is the same as the above described MIS structure, except that the upper metal electrode 403 is not microfabricated monolithically; rather, the top electrode (probe) is added externally and vibrated harmonically using a piezoelectric actuator 405 at angular frequency ω. The alternating voltage signal between the probe and the device under test (polar semiconductor structure) at frequency ω(V_{ω}) is monitored whilst sweeping the DC offset voltage (V_{DC}) between the probe and device. When V_{DC} equals the contact potential difference (V_{cpd}), V_{ω} is minimized. If the probe work function (φₘ) is known, the Schottky barrier height of the device can be calculated according to

qV_{DC}=ϕₘ−ϕ_{b}.

Mechanical Deformation

Measurement of a mechanical deformation of a membrane by the piezoelectric effect. Because the materials discussed in this present disclosure do not exhibit inversion symmetry, the resulting piezoelectricity can convert a mechanical deformation into a change in the Schottky barrier height (Δφ_{b}) following [35],

\sqrt{ϕ_{b0}+Δϕ_{b}}=\sqrt{ϕ_{b0}}±αd₃₁ϵ₂ₛ,

where α=c*/(2 qN_{d}ε₀εᵣ) and c* is the elastic stiffness for the given experimental configuration, d₃₁ is the direct piezoelectric coefficient, and ϵ₂ₛ is the surface strain. As shown in FIG. 14D, typically, the mechanical deformation is measured by reflecting a laser beam 501 from the sample 503 comprising a polar semiconductor structure, which is configured in a singly clamped cantilever geometry 505, and monitoring the vibration amplitude with a position-dependent detector 507. A light source 509 chopped 511 at the cantilever fundamental mechanical vibration frequency induces harmonic vibrations.

An advantageous embodiment of the present disclosure concerns a polar semiconductor structure 103 comprising a 2DEG. This embodiment is found to advantageously provide due high sensitivity (for example, a 2DEG can be located close to the outer surface 107, for example, placed 4 nm from the surface), provide a device that is of compact size, and assure low measurement complexity.

The measurement means 109 can be connected to and communicate with the calculator or calculation means 111 and is configured to provide the measured values MV, for example measured sheet resistance values, to calculator or calculation means 111.

The control means or controller 115 configured to change the optical output power of the light source 105 includes, for example, a current driver and current controller device for delivering current to the light source 105 and controlling the current intensity provided. This allows the optical output power emitted by the light source 105 to be modified to increase or decrease the optical output power provided to the semiconductor structure 103.

Alternatively or additionally, the control means or controller 115 may comprise an optical intensity filter to vary the optical power provided to the semiconductor structure 103.

The control means or controller 115 can be connected to and communicate with the calculator or calculation means 111. The calculation means 111 is configured to provide a command signal to the controller 115 to increase or decrease the optical output power provided the semiconductor structure 103, for example, by varying the provided drive current, and/or by varying the quantity of light filtered by the optical intensity filter.

In particular, the calculation means 111 is configured to provide a command signal to the controller 115 to change the optical output power of the light source 105 to a level that (substantially) results in the measured value MV matching or equaling the setpoint value VSP. The optical output power of the light source 105 is thus changed to a value or level where a photoinduced desorption rate and a gas adsorption rate is balanced or (substantially) equal.

The calculation means 111 is configured to change the optical output power of the light source 105 in reaction to a change in gas pressure acting on the exposed surface 107 of the polar semiconductor structure 103 (determined from a change in the measured value MV from a setpoint value VSP) to operate the device 101 in a steady-state where a photoinduced desorption rate and a gas adsorption rate is balanced or (substantially) equal.

The determination means 117 configured to determine or measure the optical output power or the change in optical output power OP of the light source 105 comprises, for example, an optical power meter configured to operate at the emission wavelength of the light source 105 and, for example, displaceable to intermittently measure the optical output power provided to the semiconductor structure 103.

The optical power meter may include a processor and a memory (for example, semiconductor memory, HDD or flash memory) configured to store or stores a program or processor executable instructions permitting to store in its memory, a history of regularly measured optical output power values and to calculate and provide a value that is or represents a change in the optical output power OP of the light source 105 between the current value and the previously measured value.

Alternatively, the determination means 117 may include an optical power determination device connected to and in communication with the controller 115. The optical power determination device is, for example, configured to receive a current intensity value currently applied to the light source 105 or an optical filter value currently being used by the controller 115. The optical power determination device may include a processor and a memory (for example, semiconductor memory, HDD or flash memory) configured to store or stores a program or processor executable instructions permitting to determine from one of these received values, a corresponding optical output power value. This can be done using, for example, a stored data-set or a look-up table stored in its memory and containing correspondence values between such values and optical output power values.

The memory can also be configured to store or stores a program or processor executable instructions permitting to store in the memory a history of regularly determined optical output power values and to calculate and provide a value that is or represents a change in the determined optical output power OP of the light source 105 between the current value and the previously measured value.

The determination means 117 can be connected to and communicate with the calculation means 111 and is configured to provide the measured or determined optical output power or the change in optical output power OP of the light source 105 to calculation means 111.

The calculator or calculation means 111 may comprise or consist of, for example, a microprocessor or a computer. The storage means 112 may comprise or consist of a memory (for example, semiconductor memory, HDD or flash memory) that may be part of the calculation means 111 or alternatively contained in another part of the gas pressure measurement device 101. The calculation means 111 is connected to and communicates with the memory 112.

The memory 112 can be configured to store or stores one or more programs or processor executable instructions that, when executed by the calculator 111, permit to control the gas pressure measurement device 101 and command elements of the gas pressure measurement device 101 such as the controller 115.

The memory 112 can also be configured to store or stores one or more programs or processor executable instructions that, when executed by the calculator 111, permit to receive data values from elements of the gas pressure measurement device 101 such as the measurement means 109 and the determination means 117, to access and/or store data in the memory 112 and to process received or accessed data to calculate or determine a gas pressure value, as set out herein.

The memory 112 can, for example, be configured to store or stores one or more programs or processor executable instructions that, when executed by the calculator 111, permit to compare the measured value MV representing a gas adsorption rate or a change in gas adsorption rate with the stored predetermined setpoint value VSP representing a balance between photoinduced desorption and gas adsorption on the surface 107 of the polar semiconductor structure 103.

Similarly, the calculator 111 is configured in this manner to command the controller 115 to change the optical output power of the light source 105 to substantially match the measured value MV with the stored setpoint value VSP, and to determine a pressure value PV based on (i) the above mentioned data set DS and (ii) the measured or determined optical output power value of the light source 105 or the measured or determined change in optical output power value of the light source 105.

In an exemplary embodiment of the present disclosure in which the measurement means 109 measures a surface charge value or a sheet resistance value of the surface 107 of the polar semiconductor structure 103, a comparison of the measured surface charge value or sheet resistance value with at least one predetermined setpoint surface charge value VSP or setpoint sheet resistance value VSP of the polar semiconductor structure is carried out, the controller 115 changes an optical output power of the light source to substantially match the measured surface charge value with the at least one setpoint surface charge value VSP or the measured sheet resistance value with the at least one setpoint sheet resistance value VSP, the optical output power value (or the change in optical output power) of the light source 105 at which the measured surface charge value or the measured sheet resistance value substantially matches the setpoint surface charge value VSP or setpoint sheet resistance value VSP is measured or determined, and the calculation means 111 is configured to determine a pressure value PV based on the stored data set DS and the measured or determined optical output power or change in optical output power value of the light source. The data set DS contains data associating, for the at least one predetermined setpoint surface charge value VSP or setpoint sheet resistance value VSP, (i) a plurality of pressure values PV with (ii) optical output power values or changes in optical output power values of the light source 105.

The calculation means 111 is, for example, configured to determine a pressure value PV by determining a pressure value PV of the data set DS corresponding to or associated with the measured or determined optical output power or change in optical output power.

The control means 115 is configured to change an optical output power of the light source 105 to balance photoinduced desorption and gas adsorption rates.

The gas pressure measurement device 101 may include a plurality of predetermined setpoint values VSP, or setpoint surface charge values VSP or setpoint sheet resistance values VSP of the polar semiconductor structure 103. The storage means 112 may include data associating, for each setpoint value VSP or each predetermined setpoint surface charge value VSP or each setpoint sheet resistance value, (i) a plurality of pressure values PV with (ii) optical output power values or changes in optical output power values of the light source 105.

The stored data may, for example, comprise a time series dataset. This may be used, for example, during the computation of integral and derivative terms in a proportional-integral-derivative control (PID) loop; and/or for providing additional data to a device user.

The light source 105 may comprise or consist of, for example, a LED or diode laser. The light source 105 is configured to emit light to generate photoinduced desorption of gas atoms or molecules on the outer gas exposed surface 107 of the polar semiconductor structure 103. The light source 105 is, for example, configured to emit light to generate free-carriers in the polar semiconductor structure 103. The light source 105 is configured to emit light to generate free-carriers in a gas exposed external material layer of the polar semiconductor structure 103.

The light source 105 is configured, for example, to emit light at a photon energy above the band gap energy of the constituent material of the external exposed semiconductor layer defining the surface 107 of the polar semiconductor structure 103, that is, the exposed semiconductor layer or material to which a gas directly attaches or is adsorbed.

The constituent material of the external exposed semiconductor layer can, for example, be chosen and/or the light source 105 can for example be configured to emit light at a photon energy above the band gap energy of the constituent material of the external exposed semiconductor layer so that light is only absorbed (or majorly absorbed) in the external exposed semiconductor layer and not in other layers or materials of the polar semiconductor structure 103.

The light source 105 may be an external light source or an internal light source monolithically included in the polar semiconductor structure 103.

The semiconductor structure comprises or consists solely of a polar semiconductor structure. The polar semiconductor structure has, for example, a natural charge separation in the absence of an electric field.

The polar semiconductor is, for example, a compound semiconductor for which principal crystal planes have a net positive or negative charge. The polar semiconductors can, for example, have a wurtzite (hexagonal) crystal structure (III-N, CdS, CdSe, ZnSe, ZnO).

The polar semiconductor structure may be a two-dimensional electron gas (2DEG) semiconductor structure or comprises layers or materials that induce or generate a 2DEG, for example, a polarization-induced 2DEG. In such a case, the measurement means 109 is, for example, configured to measure a 2DEG sheet resistance value of the polar semiconductor structure 103.

The polar semiconductor structure 103 can be or may define a III-Nitride semiconductor structure. The III-Nitride semiconductor structure may, for example, comprise or consist of a substrate (for example, a III-N substrate) and a III-Nitride semiconductor layer provided directly or indirectly thereon, this layer defining the outer surface 107.

The polar semiconductor structure 103 may, for example, includes one or more III-Nitride layers or materials configured to induce or generate a 2DEG, and a capping layer provided directly or indirectly on the one or more III-Nitride layers. The capping layer defines the outer layer of the structure and defines the surface 107. The capping layer can for example, comprise or consist of InGaN.

An outer layer of the semiconductor structure 103 defining the external surface 107 of the semiconductor structure 103 may, for example, define a capping or passivation layer of the semiconductor structure 103, or may for example define a barrier layer of a FET structure and/or a structure configured to induce or generate a 2DEG.

The outer layer of the polar semiconductor structure 103 comprises or consists of a material assuring that optically generated carriers in this layer electrochemically react with adsorbed gas species to create chemisorbed gas-nitride complexes, which modify the Schottky barrier height of the polar semiconductor structure 103.

The polar semiconductor structure 103 may comprise or consist of a FET device. The polar semiconductor structure 103 may, for example, further include a thin film heater and/or a suspended gate electrode.

The external surface 107 of the semiconductor structure 103 can be treated or functionalized to selectively capture one or more particular gas atoms or molecules. This permits a partial gas pressure to be measured. All or part of the surface 107 may be rendered chemically selective to certain gases by modification of the near-surface semiconductor layer's alloy composition (for example, the fraction of In, Al, Ga in the case of III-Nitride materials). Functionalization could alternatively or additionally be carried out by doping of the layer defining the external surface 107, or alternatively or additionally by heating to set the gauge temperature operation to one favoring a targeted gas and additionally or alternatively by applying an external electric field.

FIGS. 1(a) and 1(b) is an image of an exemplary prototype of a polar semiconductor structure 103 of a gas pressure measurement device 101 according to the present disclosure. FIG. 1(a) shows an exemplary 8×12 mm² chip containing the polar semiconductor structure 103 that is bonded in a chip carrier. Each chip contains four gauges or devices, whose active area (central square region shown in FIG. 1(b)) ranges, for example, between 2.5 and 10 μm².

The gas pressure measurement device 101 can be, for example, included and used in a vacuum chamber to measure gas pressures or partial gas pressures therein. The vacuum chamber may for example be part of a material deposition and/or characterization system. All elements of the gas pressure measurement device 101 may be included in the chamber or only some parts thereof, for example, the polar semiconductor structure 103 and elements of the measurement means 109 cooperating with the polar semiconductor structure 103 to permit the measurement of the value MV representing a gas adsorption rate or a change in gas adsorption rate on the surface 107 of the polar semiconductor structure 103. The present disclosure also concerns a vacuum chamber, or material deposition and/or characterization system including the vacuum pressure gauge or the gas pressure measurement device 101.

As mentioned, the gas pressure measurement device 101 of the present invention can be used to measure a gas pressure or partial gas pressure in a chamber defining or confining a controlled environment, for example, a vacuum chamber, a hermetic chamber or a chamber having a general function to confine or define an environment or a controlled environment. The gas pressure measurement device 101 can be used, for example, for combustion gas monitoring or environmental sensing.

The present disclosure also concerns a gas pressure measurement method. The method includes providing the polar semiconductor structure 103, measuring a value representing a gas adsorption rate or a change in gas adsorption rate on the surface 107 of the polar semiconductor structure 103, comparing the measured value MV with at least one predetermined setpoint value VSP representing a balance between photoinduced gas desorption and gas adsorption on the surface 107 of the polar semiconductor structure 103.

If the measured value MV is different to the at least one predetermined setpoint value VSP, the optical output power of a light source 105 illuminating the polar semiconductor structure 103 is changed (increased or decreased) to (substantially) match the measured value MV with the setpoint value VSP.

The measured value MV can be considered different to the at least one predetermined setpoint value VSP if, for example, there is simply a difference between the values, or alternatively if for example there is a difference between the values that is >1% or >5% or >10% of the setpoint value VSP. The particular mode of operation of the device 101 desired will determine the difference value to be used.

The method may further include determining or measuring the optical output power or the change in optical output power of the light source 105 at which the measured value (substantially) matches the setpoint value VSP, and providing the at least one data set DS associating, for the at least one predetermined setpoint value, (i) a plurality of pressure values PV with (ii) optical output power values or changes in optical output power values of the light source 105. A pressure value PV is then determined based on the content of the at least one data set DS and the measured or determined optical output power value of the light source 105 or the measured or determined change in optical output power value of the light source 105. This done, for example, by determining from the entries in the data set DS, the pressure value PV that is associated with the measured or determined optical output power value or change in optical output power value.

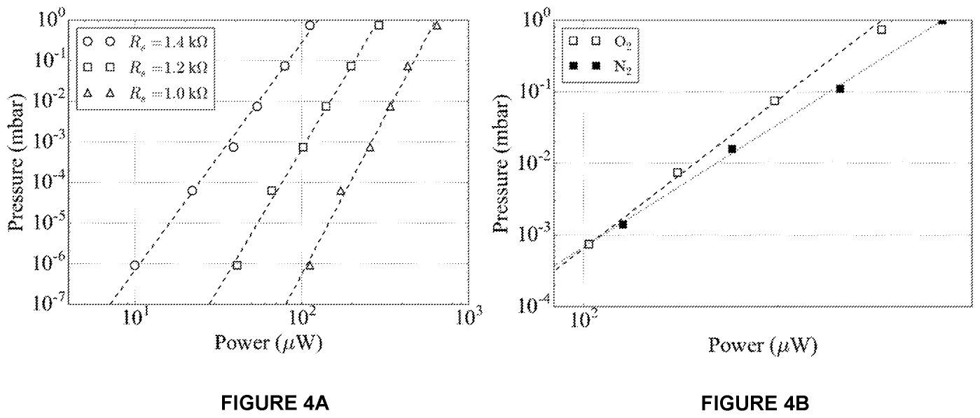

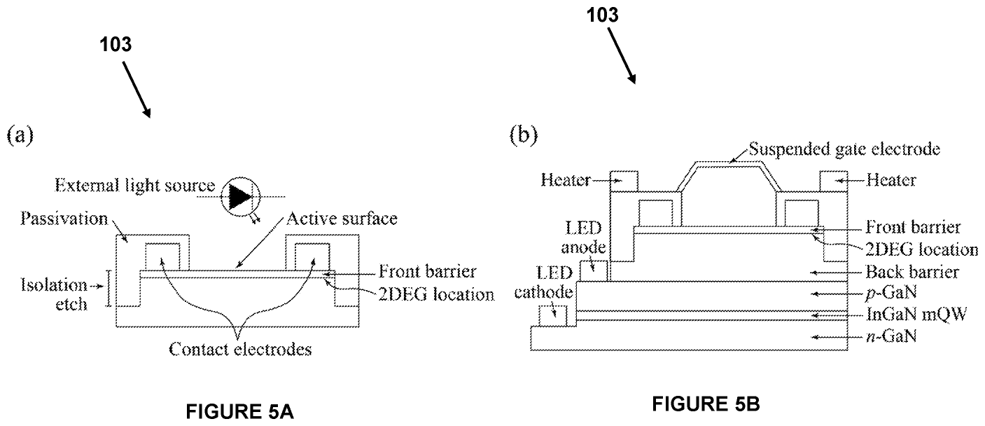

FIG. 4A shows, for example, three different data sets DS each corresponding to a different setpoint value VSP that in this example is defined by a sheet resistance R. The three different setpoint values VSP are thus 1.0, 1.2 and 1.4 Id/In this example, each data set DS contains data associating optical power values with pressure values. The gas pressure measurement device 101 may include one of more data sets DS permitting to determine a gas pressure value PV, for example the three data sets DS plotted in FIG. 4A.

As can be seen from FIG. 4A, the determination of the value of the optical output power (or the change in optical output power value from an initially known value) of the light source 105 that brings the measured value MV back to the setpoint value VSP permits a gas pressure value to be determined, for example, by reading the stored pressure value PV directly associated with or corresponding to the optical output power value (or the change in optical output power value) also stored in the data set DS. The gas pressure measurement device 101 may, for example, include one of more data sets DS for a predetermined temperature value or temperature range in which the gas pressure measurement device 101 is operating. The gas pressure measurement device 101 can include a temperature measuring device or be configured to receive a measured temperature value and the gas pressure measurement device 101 is configured to select the data set DS to be used in the determination of the pressure value that corresponds to the measured temperature value or temperature range.

The light source 105 is configured to provide an illumination intensity at a value or range of values that permits a linear response of the measured value MV thus permitting a fast device response.

The data set DS can include data concerning or defining a linear response or a power law response of pressure values PV and optical output power of the light source for at least one setpoint value VSP, or the setpoint surface charge value or setpoint sheet resistance value.

In an exemplary embodiment of the method, the measuring step comprises measuring a surface charge value or a sheet resistance value of the polar semiconductor structure 103. The comparing step compares the measured surface charge value or sheet resistance value with the at least one predetermined setpoint surface charge value VSP or setpoint sheet resistance value VSP of the polar semiconductor structure 103, and the optical output power of the light source 105 is changed to (substantially) match the measured surface charge value with the at least one setpoint surface charge value or the measured sheet resistance value with the at least one setpoint sheet resistance value.

The determining or measuring step determines or measures the optical output power of the light source 105 at which the measured surface charge value MV or the measured sheet resistance value MV (substantially) matches the at least one setpoint surface charge value VSP or setpoint sheet resistance value VSP, or the change in optical output power of the light source 105 required such that the measured surface charge value MV or measured sheet resistance value MV (substantially) matches the at least one setpoint surface charge value or setpoint sheet resistance value.

The at least one data set DS associates, for the at least one predetermined setpoint surface charge value VSP or setpoint sheet resistance value VSP, (i) a plurality of pressure values PV with (ii) optical output power values or changes in optical output power values of the light source 105, and a gas pressure value PV is determined based on said at least one data set DS.

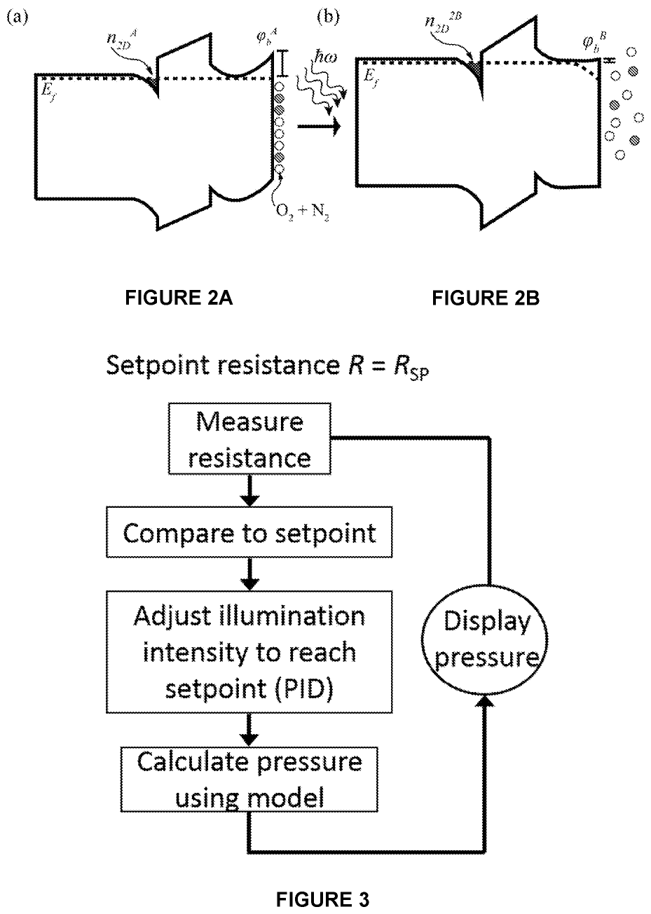

The vacuum gauge or gas pressure measurement device 101 of the present disclosure thus may comprises three elements, (1) a variable intensity light source 105, (2) a field-effect transistor (FET) 103 as shown in FIGS. 1A and 1B, and (3) a feedback loop FBL connecting elements (1) and (2). The principle of photoinduced ad- and de-sorption of gas from the semiconductor surface 107, a phenomenon unique to polar semiconductor materials, especially for example III-nitride semiconductor materials, provides the physical basis for the measurement. When light containing photons of sufficient energy and intensity is shone on the semiconductor 103, physically and/or chemically adsorbed gas molecules on the surface desorb. The gas desorption changes the charge of the semiconductor surface (FIG. 2).

By growing, for example, a specific sequence of III(Group III: Al, Ga, In)-nitride layers, the change in semiconductor surface charge can be transduced to an easily measurable change in the sheet resistance of a two-dimensional electron gas (2DEG) near the surface. As is well known in the art, either a two (transistor configuration), three, or four electrode (Van der Pauw geometry and method, FIG. 1B) may be used to measure the sheet resistance. The four-electrode configuration is preferable to minimize the measured contribution of contact resistance. Details on the conversion of sheet resistance to surface charge is discussed further below.

The feedback loop FBL (3) modulates the intensity of the light source 105 to maintain a constant sheet resistance setpoint VSP, such as that shown for example in FIG. 3. The ambient gas pressure or partial gas pressures control the rate of gas adsorption on the surface 107. The light source intensity governs the rate of photoinduced gas desorption. When photoinduced desorption and gas adsorption rates are balanced, the illumination intensity required to maintain the sheet resistance setpoint VSP is related to the gas pressure or partial gas pressure by a simple power law (FIG. 4). A derivation of the power law is provided later. Operation of the gauge 101 at a steady-state, constant sheet resistance setpoint SVP via the feedback loop FBL advantageously achieves real-time (few second) operation. The feedback loop FBL solves a slow, logarithmic time response issue known to the state-of-the-art, which is further discussed below.

The feedback loop (FIG. 3) functions for example by measuring the sheet resistance, comparing the current sheet resistance MV to the setpoint value VSP, and increasing or decreasing the light intensity to move the current sheet resistance MV closer to the setpoint value VSP. For example, at each feedback loop iteration, the current light intensity can be translated to pressure PV by a calibration curve or lookup table DS.

The feedback loop FBL may be implemented or comprise one of more configurations known in the state-of-the-art, such as proportional (P) control, or proportional-integral-derivative control (PID).

Multiple sheet resistance setpoints for different vacuum ranges may be desirable. For instance, a high sheet resistance setpoint SVP may be desirable for high vacuum (<10⁻³ mbar) as compared medium vacuum (>10⁻³ mbar) operation because the illumination intensity required to maintain constant sheet resistance decreases with pressure.

FIGS. 5A and 5B show possible exemplary embodiments of elements (1) and (2). Namely, the light source 105, such as a light-emitting diode or laser diode, that may be integrated externally. In III-nitride materials, the light source may also be integrated internally during the growth of the layers. Preferably, the illumination photon energy (substantially) equals or exceeds the bulk band gap of the front barrier III-nitride material. FIG. 5B also shows optional elements, such as (4) a suspended gate electrode or (5) a heating element, which further improve device response time.

Partial gas pressure refers to a measurement environment comprised of several chemical species, each with its own partial pressure. The III-nitride semiconductor surface may be rendered chemically selective to certain gases by modification of the near-surface semiconductor layer's alloy composition (fraction In, Al, Ga), functionalization, and/or doping of the said layer, in addition to the gauge temperature and or external electric field. Although a gas-independent response is desirable in the vacuum gauge application, vacuum gauges for (ultra)high vacuum exhibiting a gas-dependence are also desirable. Chemical selectivity may for example be desirable for use of the vacuum gauge 101 as a gas sensor or for sensing a specific contaminant gas (e.g. oxygen or water vapor), especially in a vacuum environment.

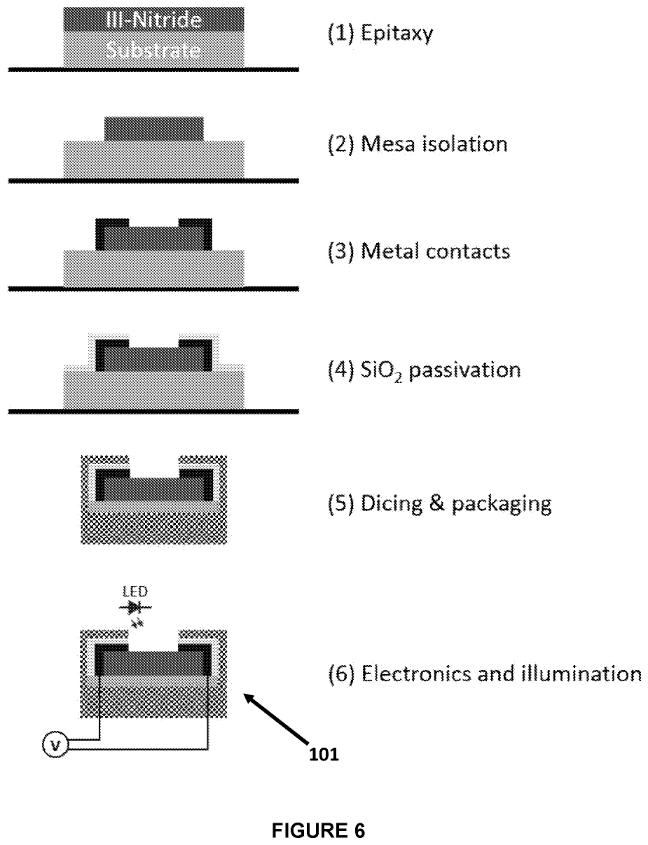

FIG. 6 shows one exemplary process flow for the creation of an exemplary gauge of the present disclosure. A substrate wafer, such as sapphire, silicon, or silicon carbide, can be purchased from a commercial supplier. The crystal epilayers can be grown, for example, by metal-organic vapor phase epitaxy (FIG. 6-1). Then, the gauge area is defined by photolithography and reactive ion etching (FIG. 6-2). Next, metal electrodes are aligned to the mesa by lift-off photolithography and metal evaporation and annealed to lower the contact resistance, as is known in the state-of-the-art (FIG. 6-3). Then, the entire device with the exception of the gauge surface 107 is covered by a passivating layer (FIG. 6-4), such as SiO2, by any one of a number of techniques, such as plasma-enhanced chemical vapor deposition. Finally, the individual chips are diced and bonded in a ceramic wafer carrier with an external light-emitting diode (FIG. 6-5), mounted in a vacuum flange with electrical feedthroughs, and connected to signal processing electronics on the air side of the flange (FIG. 6-6).

Additional details are now presented explaining the technical operation of the device of the present disclosure. First, the Inventors show how the measured quantity, resistance, is related to the surface potential, which is then linked to surface charge by the Poisson equation. The Inventors then explain the origins of the logarithmic time dependence in the prior state-of-the-art and demonstrate quantitatively why the current invention enables a real-time response. Finally, the Inventors derive the power law relationship between illumination intensity and ambient pressure based on the condition of constant surface potential.

Signal Transduction:

FIG. 7 explains how the measured resistance signal is converted into the surface potential, ϕ_{b}. First, a sheet resistance (Rₛ) measurement using, for example, the van der Pauw technique is performed; a

$${R}_{12 , 34} = \frac{{V}_{34}}{{I}_{12}} \qquad ( 1 )$$

constant current I₁₂ is applied across adjacent electrodes 1 & 2 and the voltage drop across electrodes 3 & 4 is measured. Via Ohm's Law (Eq. 1), the measured resistance R_{12,34} is computed. Assuming a symmetric device (R_{12,34}=R_{23,14}), the sheet resistance (Rₛ) can be computed using the van der Pauw formula (Eq. 2),

$${e}^{- π {R}_{12 , 34} / {R}_{s}} + {e}^{- π {R}_{23 , 21} / {R}_{s}} = 1 , \\ {R}_{s} = - \frac{π {R}_{12 , 34}}{ln ( 1 / 2 )} . \qquad ( 2 )$$

The sheet resistance is related to the 2DEG density (n_{2D}) by the simple relation,

$${n}_{2 D} = \frac{1}{{qR}_{s} μ} . \qquad ( 3 )$$

In Eq. 3, q is the fundamental charge of an electron and μ is the 2DEG carrier mobility.

In real-world operation, both n_{2D} and μ are temperature dependent. Therefore, Hall effect measurements calibrate out the temperature-dependent relative contributions of n_{2D} and μ to Rₛ. FIG. 8 demonstrates that the mobility, μ, linearly depends on temperature, whereas the 2DEG density, n_{2D}, is essentially independent of temperature. In one embodiment, to render μ insensitive to temperature a limiting scattering mechanism is included or introduced during epitaxy which dominates thermal scattering. Therefore, this additional calibration step allows us to perform temperature-dependent measurements of n_{2D} and therefore ϕ.

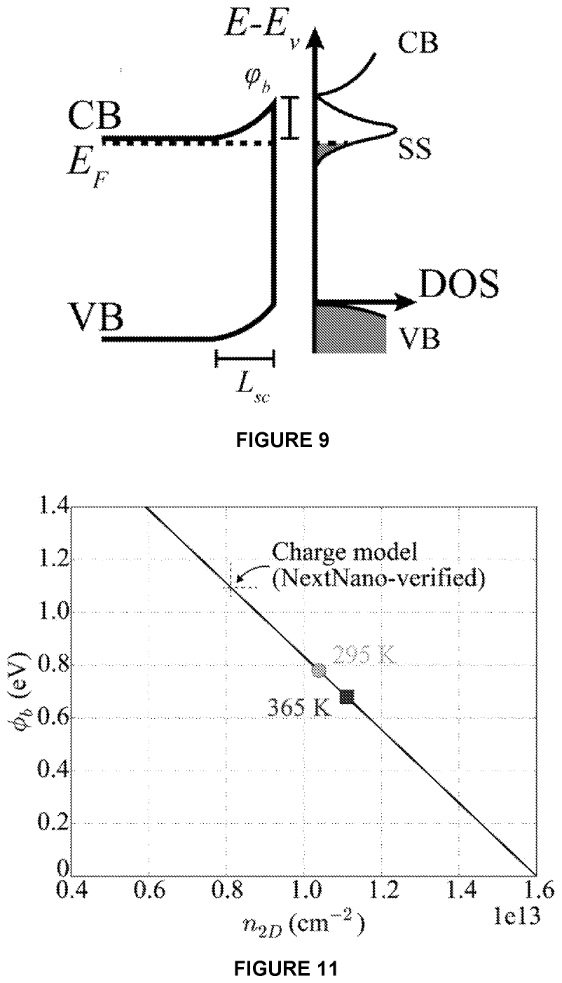

A charge model relates ϕ_{b} to n_{2D}. To understand the charge model in layers designed to create a 2DEG, the Inventors first treat a simpler case of a bulk GaN layer. On III-nitride surfaces, the Fermi level (E_{F}) is pinned at an energy within the bulk material's band gap by a high density of intrinsic surface states [15-17]. A Schottky barrier of height ϕ_{b} forms to ensure E_{F} is constant throughout the band diagram in thermal equilibrium (FIG. 9). A space charge region of width L_{sc} is created in order to ensure charge neutrality. In the one-sided abrupt junction approximation, the L_{sc} follows an inverse square root dependence on the extrinsic (ionized impurity) carrier concentration, N_{d}, [25]

$${L}_{sc} = \sqrt{\frac{2 {ɛ}_{0} {ɛ}_{r}^{GaN}}{{q}^{2} {N}_{d}} {ϕ}_{b}} . \qquad ( 4 )$$

For a typical level of unintentional n-type doping in GaN, N_{d}=1×10¹⁷ cm⁻³ and ϕ_{b}=0.8 eV, L_{sc}=65 nm. Since global charge neutrality must be ensured so that no electric field exists outside the semiconductor, the charge due to charged surface states (nₛₛ) is: q nₛₛ=q N_{d} L_{sc}.

Now, one can analyze the case of a polarization-induced 2DEG based on III-nitride semiconductors. Because III-nitride semiconductors typically crystallize in a hexagonal wurtzite structure, the positive and negative charge barycenters do not overlap in the unit cell, giving rise to a permanent spontaneous polarization (Pₛₚ) dipole aligned with the conventional growth axis (+c) for epitaxial layers [26]. To ensure continuity of the normal component of the electric displacement field at the interface between materials, a sheet charge equal to the difference in Pₛₚ between materials forms at each interface. In addition to the piezoelectric polarization induced by material strain (P_{pz}), the spontaneous polarizations between materials can be engineered to form a potential well for electrons with a first energy level below E_{F}, forming a 2DEG. This is well-known in the state-of-the-art for III-nitride materials. The main application for III-nitride 2DEGs is high-electron mobility transistors (HEMTs) for power electronics [27].

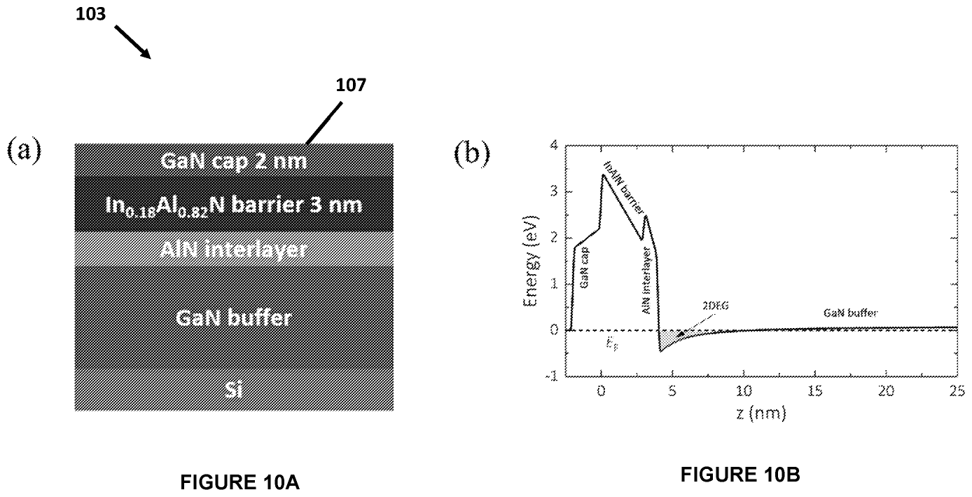

An exemplary epitaxial structure of the present disclosure is shown in FIG. 10A alongside the corresponding band diagram in FIG. 10B computed using a commercial software that self-consistently

ϕ_{b}=q(F_{GaN}t_{GaN}+F_{InAlN}t_{InAlN}+F_{AlN}t_{AlN})+ΔE_{C}(GaN→InAlN)+ . . . ΔE_{c}(InAlN→AlN)+ΔE_{c}(AlN→GaN). (5)

solves the coupled Poisson and Schrödinger equations in the k·p approximation for electrostatics and quantum mechanics, respectively [28]. The surface Fermi level is still pinned at energy ϕ_{b} below the conduction band minimum. However, in contrast to the bulk material case (FIG. 9), the energy bands bend downwards rather than upwards at the surface of the n-GaN because the space charge in the thin GaN cap is insufficient to screen the strong electric fields generated by the spontaneous polarization. Even in this more complicated structure, E_{F} remains constant in thermal equilibrium. Combined with the band diagram, a simple relationship between ϕ_{b} and n_{2D} can be constructed [27],

ΔE_{c} are the conduction band offsets, t are the material thicknesses, and F are the electric fields in each material, which can be found using Eqs. 6-8,

$$\begin{matrix}{F}_{GaN} = \frac{1}{{ɛ}_{0} {ɛ}_{r}^{GaN}} [ {P}_{sp} ( GaN \to InAlN ) + {P}_{sp} ( InAlN \to AlN ) + … {P}_{sp} ( AlN \to GaN ) - {qn}_{2 D} ] , & ( 6 ) \\ {F}_{InAlN} = \frac{1}{{ɛ}_{0} {ɛ}_{r}^{GaN}} [ {P}_{sp} ( InAlN \to AlN ) + {P}_{sp} ( AlN \to GaN ) - {qn}_{2 D} ] , & ( 7 ) \\ {F}_{AlN} = \frac{1}{{ɛ}_{0} {ɛ}_{r}^{AlN}} [ {P}_{sp} ( AlN \to GaN ) - {qn}_{2 D} ] . & ( 8 )\end{matrix}$$

Table 1 lists the parameters that were used to evaluate the model for the exemplary test structure. Note that, in the model, the negligible piezoelectric polarization in the AlN layer has been ignored. The charge model in Eqs. 5-8 captures the behavior of the results from the more complex self-consistent Schrödinger-Poisson numerical model.

TABLE 1
Parameters used for the charge model [32].

| Symbol | Description | Value | SI Units |
|---|---|---|---|
| q | Fundamental charge | 1.603 × 10⁻¹⁹ | C |
| ε₀ | Vacuum permittivity | 8.85 × 10⁻¹² | F-m⁻¹ |
| εᵣ^{GaN} | Relative permittivity, DC | 9.5 | Unitless |
| εᵣ^{InAlN} | Relative permittivity, DC | 10.1 | Unitless |
| εᵣ^{AlN} | Relative permittivity, DC | 8.6 | Unitless |
| ΔE_{c}(GaN → InAlN) | Conduction band offset | −q · 0.9 V | J |
| ΔE_{c}(InAlN → AlN) | Conduction band offset | −q · 0.8 V | J |
| ΔE_{c}(AlN → GaN) | Conduction band offset | +q · 1.7 V | J |
| Pₛₚ(GaN → InAlN) | Spontaneous polarization | +6.64 × 10¹⁷ | C-m⁻² |
| Pₛₚ(InAlN → AlN) | Spontaneous polarization | −3.57 × 10¹⁷ | C-m⁻² |
| Pₛₚ(AlN → GaN) | Spontaneous polarization | −3.07 × 10¹⁷ | C-m⁻² |
| t_{GaN} | Cap thickness | 2 × 10⁻⁹ | m |
| t_{InAlN} | Spacer thickness | 3 × 10⁻⁹ | m |
| t_{AlN} | Polarization layer | 1 × 10⁻⁹ | m |
| | thickness | | |

The Inventors verified the charge model experimentally. It is known in the state-of-the-art that light with sub-bulk band gap photon energy can be absorbed by surface states [17]. The absorbed photon may promote an electron from a localized surface state to the bulk continuum of states in the conduction band or can cause electron capture from the valence band bulk continuum of states by a localized surface state (FIG. 9), leaving behind a hole in the valence band of the bulk material. The photogenerated carrier in the bulk continuum of states may be accelerated away from the surface by the built-in electric field at the surface, leaving behind a charged surface state. Thus, illumination has the tendency to decrease ϕ_{b}. Sub-band gap illumination does not result in photoinduced desorption or adsorption in III-nitride materials, as known in the state-of-the-art [17] and verified by our own measurements.

FIG. 11 shows the charge model with two experimental data points at 295 and 365 K. Decreases in the Schottky barrier height, ϕ_{b}, increase 2DEG density, n_{2D}. Flat band conditions (n_{2D}^{max}, ϕ_{b}=0) were found by illuminating the structure with a laser with photon energy less than the bulk band gaps of all materials in the structure until no further increases in laser intensity changed the sheet resistance. The charge model's x-intercept (FIG. 11) was then set to the experimental density corresponding to flat band conditions (n_{2D}^{max}). The two experimental data points correspond to ϕ_{b}=0.7-0.8 eV in the dark, in excellent agreement with Schottky barrier height on c-plane GaN surfaces measured in the literature [15,17].

The exemplary prototype gauge is driven by illumination with photons of energy above the band gap energy of the cap material. In this case, photon absorption efficiently generates electron-hole pairs in the bulk cap material, which may be swept to the surface by the built-in field. Based on our experimental laser intensity of 100 W/cm² and the short photogenerated carrier lifetime (τ_{PL}) of <100 ps in these materials at room temperature due to fast nonradiative recombination, the steady-state photogenerated carrier density remains extremely low, around Nₚₕ≈1×10¹⁶ cm⁻³. Therefore, because one does not expect substantial screening of the static electric field by the photogenerated carriers, no modification of Eqs. 5-8 is required to account for the photogenerated charge. However, the photogenerated carriers do influence the charge on the surface nₛₛ and therefore ϕ_{b} by photoenhanced adsorption and desorption. Therefore, we apply the charge model in thermal equilibrium to the case of the illuminated device to convert the measured n_{2D} to ϕ_{b} under illumination.

System Dynamics—Slow, Logarithmic Time Response in Prior Art:

To the best of the Inventors' knowledge, no quantitative model of photoinduced desorption in 2DEG heterostructures is known in the state-of-the-art. However, models have been proposed for surface effects in homogeneous thin films. The salient aspects of those models are reviewed here and the results are applied to interpret the experimental data.

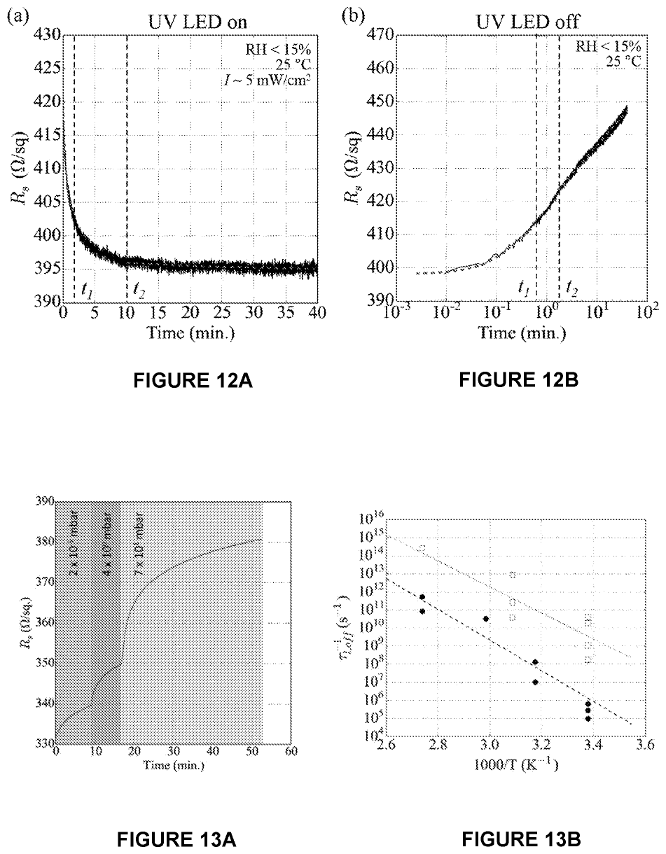

Reshchikov et al [17] considered surface photovoltage effects in n-GaN (FIG. 9) but did not account for photodesorption and photoadsorption phenomena. Nevertheless, their model can be used to reproduce the experimental time dynamics of our system (FIG. 12),

$$\frac{{dn}_{ss}}{dt} = {C}_{sb} {n}_{ss} - {C}_{bs} {n}_{GaN} {e}^{- {ϕ}_{b} / {k}_{B} T} + \frac{α I}{h v} , \qquad ( 9 )$$

where C_{sb} and C_{bs} are rate constants, a is the absorption constant, I is the illumination intensity, and hυ is the photon energy. The Schottky barrier ϕ_{b} is linked to the surface charge density nₛₛ via Eq. 4 and the charge neutrality condition, q nₛₛ=q N_{d}L_{sc}.

Eq. 9 is a nonlinear time-dependent differential equation that does not admit analytical solutions. However, under certain conditions, the numerical solutions can be approximated by analytical expressions [17]. For instance, the initial fall of ϕ_{b} under illumination occurs linearly. After illumination is switched off, the system slowly recovers to thermal equilibrium because bulk electrons must overcome the Schottky barrier of height ϕ_{b} to rebuild the negative surface charge. Each additional electron that reaches the surface further increases ϕ_{b}, which renders each subsequent electron less likely to reach the surface. The result is a logarithmic time response of ϕ_{b} at sufficiently long timescales (t>t₂), following

$${ϕ}_{b} ( t ) = A ln ( \frac{t - {t}_{0}}{{τ}_{l}} ) . \qquad ( 10 )$$

In Eq. 10, A, t₀, and τ₁ are fit parameters.

FIG. 12 shows the transient response of the prototype device of the Inventors when (a) above gap UV illumination is switched on and (b) when above gap UV illumination is switched off. When the light is turned on, the initial behavior of Rₛ (and ϕ_{b}) is linear, in agreement with Eq. 9, and saturates at some new value after a few minutes. t₂^{on}, the time at which saturation occurs, depends on the illumination intensity. By choice of sufficiently intense illumination, t₂^{on} can be reduced to less than a few seconds. When the illumination is switched off, the recovery of Rₛ (and ϕ_{b}) can be fit by an exponential at short timescales 0<t<t₁^{off}. At long timescales t>t₂^{off}, the time response is indeed logarithmic, in agreement with Eqs. 9-10. When information is extracted from the device operated in transient mode, as in FIG. 12, the logarithmic time response would render operation of the device impractical for commercial applications, as it is difficult to disentangle the impact of the measurement history from the measurement environment.

Despite the slow time response, the prototype exhibits a pressure and gas dependence when operated in transient mode (FIG. 13). Following a period of illumination, FIG. 13a shows the recovery of Rₛ (ϕ_{b}) and ϕ_{b}) in N₂ of varying pressures. A clear pressure dependence of the recovery transient is observed. However, from such a figure, is not clear how to relate the extracted time constants to the desired quantity, pressure. FIG. 13b shows the temperature dependence of the extracted logarithmic time response constants (τ₁) in N₂ and O₂ atmospheres at 1 mbar each following 40′ of irradiation under 1 kW/cm² intensity of a λ=325 nm UV laser. The dashed lines show fits to an Arrhenius equation. The extracted activation energies for N₂ and O₂ are 1.3±0.7 and 1.7±0.3 eV, respectively. Therefore, to within experimental error, both N₂ and O₂ show the same logarithmic time constants during recovery.

The solution to the logarithmic time response is to change the operating mode of the device. The Inventors propose adapting the illumination intensity dynamically to maintain constant Rₛ (ϕ_{b}) instead of monitoring changes in Rₛ (ϕ_{b}) under long periods of constant illumination intensity. Free carriers generated in the cap material by illumination with above gap photons controllably reduce ϕ_{b}. A sufficiently low ϕ_{b} improves the time response of the system to within a few seconds. Even better, non-equilibrium, steady-state device operation enables facile translation of the illumination intensity into pressure using a calibration curve. The origins of this relationship can be derived from models of chemisorption in semiconductors [29].

Relationship Between Illumination Intensity and Pressure in Steady-State Operation:

The models of chemisorption in semiconductors employ a rate equation similar to Eq. 9, but couple this equation to one or more subsequent rate equations that track the number of adsorbed molecules. Again, nonlinear coupling is induced through the Schottky barrier, ϕ_{b}. The prior art [30,31] does not consider the case of photoinduced adsorption and desorption. Moreover, such models have not yet been applied to 2DEG heterostructures. The Inventors highlight herein an application of an existing result to their system.

FIG. 4 provides experimental evidence that the relationship between pressure and illumination intensity follows a simple power law in the gauge of the present disclosure. Rothschild and Komem [30] computed ϕ_{b} isotherms (constant temperature) in thermal equilibrium for n-SnO₂ thin film gas gauges as a function of O₂ pressure (P) and bulk doping level, Na. The authors found that, over a wide range of parameters, the ϕ_{b} could be fit to a simple two-parameter function,

ϕ_{b}=A ln(P)+B ln(N_{d}).

A and B are fit constants. Because the Fermi level in our 2DEG gauge (FIG. 10b) passes through the middle of the GaN cap, the photogenerated carrier density (Nₚₕ) is higher than the extrinsic carrier density in the cap. If we assume that Nₚₕ is proportional to the laser intensity (I), as it should be under the current experimental conditions, then constant operation corresponds to the case,

$$\frac{d {ϕ}_{b}}{dI} = 0 \qquad ( 12 )$$

Differentiating Eq. 11 and solving for I leads to a simple power law relationship with pressure,

$$I ( P ) {\vert}_{{ϕ}_{b}} = {{I}_{0} ( \frac{P}{{P}_{0}} )}^{A / B} . \qquad ( 13 )$$

In Eq. 13, I₀ and P₀ are constants.

While an exemplary embodiment has been described using a 2DEG heterostructure, this is not necessary. In another embodiment according to the present disclosure, the heterostructure device may not comprise a 2DEG heterostructure.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

### REFERENCES

[1] K. I. Lundström, M. S. Shivaraman, & C. M. Svensson (1975). A hydrogen-sensitive Pd-gate MOS transistor. J. Appl. Phys., 46(9), 3876-3881.
[2] C. Senft, P. Iskra, I. Eisele “Theory and Application of Suspended Gate FET Gase Sensors” (2012) in Solid State Gas Sensors—Industrial Application. (M. Fleischer & M. Lehmann, Eds.) (Vol. 11). Berlin, Heidelberg: Springer Berlin Heidelberg.
[3] J. Schalwig, G. Müllner, O. Ambacher, & M. Stutzmann. (2001). Group-III-Nitride Based Gas Sensing Devices. Physica Status Solidi (a), 185(1), 39-45.
[4] M. Eickhoff, J. Schalwig, G. Steinhoff, O. Weidemann, L. Görgens, R. Neuberger, M. Hermann, B. Baur, G. Müller, O. Ambacher, & M. Stutzmann (2003). Electronics and sensors based on pyroelectric AlGaN/GaN heterostructures—Part B: Sensor applications. Phys. Stat. Solidi (c), 0(6), 1908-1918.
[5] S. J. Pearton, B. S. Kang, S. Kim, F. Ren, B. P. Gila, C. R. Abernathy, J. Lin, & S. N. G. Chu (2004). GaN-based diodes and transistors for chemical, gas, biological and pressure sensing. J. Phys.: Cond. Matter, 16(29), R961-R994.
[6] Song, J., Lu, W., Flynn, J. S., & Brandes, G. R. (2005). Pt-AlGaN/GaN Schottky diodes operated at 800° C. for hydrogen sensing. Appl. Phys. Lett., 87(13), 133501.
[7] S. J. Pearton, F. Ren, Y.-U. Wang, B. H. Chu, K. H. Chen, C. Y. Chang, W. Lim, J. Lin, & D. P. Norton (2010). Recent advances in wide bandgap semiconductor biological and gas sensors. Prog. Mat. Sci., 55(1), 1-59.
[8] O. Ambacher, G. Mueller, R. Neuberger, & M. Stutzmann (2000). Ion-sensitive semiconductor sensor used for measuring the pH of liquids has a succession of layers made from group III nitrides formed as an HEMT structure. DE10062044A1
[9] J.-S. Moon, N. Prokopuk, & K.-A. Son (2005). GaN-based Sensor Nodes for in situ Detection of Gases. U.S. Pat. No. 7,403,113 B2
[10] M. A. Garcia, S. D. Wolter, A. S. Brown, J. Bonaventura, & T. F. Kuech (2007). GaN-Based Nitric Oxide Sensors and Methods of Making and Using the Same. US 2008/0203431 A1
[11] A. Schober, M. Kittler, M. Gebinoga (2008). Vorrichtung zur ermittlung von physikalischen und/oder chemischen eigenschaften. WO 2009144322 Al.
[12] R. Bashir, B. Reddy, M. Al Alam, P. R. Nair, & G. Jonghyun. (2012). Coupled heterogeneous devices for pH sensing. US 2014/0139204 A1
[13] F. Ren, S. J. Pearton, & T. Lele (2014). Sensors using High Electron Mobility Transistors. U.S. Pat. No. 8,828,713 B2.
[14] B. Baur, G. Steinoff, J. Hernando, O. Perrucker, M. Tanaka, B. Nickel, M. Stutzmann, & M. Eickhoff (2005). Chemical functionalization of GaN and MN surfaces. Appl. Phys. Lett., 87, 263901.
[15] M. Foussekis, A. A. Baski & M. A. Reshchikov. (2009). Photoadsorption and photodesorption for GaN. Appl. Phys. Lett., 94(16), 162116.
[16] C. Pfüller, O. Brandt, F. Grosse, T. Flissikowski, C. Chèze, V. Consonni, L. Geelhaar, H. T. Grahn, & H. Riechert (2010). Unpinning the Fermi level of GaN nanowires by ultraviolet radiation. Phys. Rev. B, 82(4), 045320.
[17] M. A. Reshchikov, M. Foussekis, & A. A. Baski (2010). Surface photovoltage in undoped n-type GaN. J. Appl. Phys., 107(11), 113535.
[18] M. Matys, B. Adamowicz, Z. R. Zytkiewicz, A. Taube, R. Kruszka, & A. Piotrowska (2016). High-temperature ultraviolet detection based on surface photovoltage effect in SiN passivated n-GaN films. Appl. Phys. Lett., 109(5), 051106.
[19] A. Winnerl, R. N. Pereira, & M. Stutzmann (2017). Photo-induced changes of the surface band bending in GaN: Influence of growth technique, doping and polarity. J. Appl. Phys., 121(20), 205307.
[20] J. Lagowski, E. S. Sproles, & H. C. Gatos (1977). Quantitative study of the charge transfer in chemisorption; oxygen chemisorption on ZnO. J. Appl. Phys., 48(8), 3566-3575.
[21] H. C. Gatos & J. Lagowski (1975). Semiconductor sensors. U.S. Pat. No. 4,011,745
[22] A. 29 & H. L. Tuller (2008). Photo-induced sensitivity and selectivity of semiconductor gas sensors. US 2008/0110241
[23] W. Hanrieder (1990). “Verfahren zur Bestimmung der Konzentration einer Gaskomponente in einem Gasmisch.” DE 4030211C2.
[24] Inficon AG. “Leak detectors” https://products.inficon.com/en-us/nav-products/category/productgroup/leak-detectors/(Accessed 2018.04.04)
[25] S. M. Sze & K. K. Ng (2007). Semiconductor Devices: Physics and Technology (3rd ed.). Hoboken, N.J.: Wiley Interscience.
[26] H. Morkoç (2008). Handbook of Nitride Semiconductors and Devices. Weinheim, Del.: Wiley-VCH.
[27] D. Jena (2008). Polarization Effects on Low-Field Transport & Mobility in III-V Nitride HEMTs. In C. Wood (Ed.), Polarization Effects in Semiconductors: From Ab Initio Theory to Device Applications (pp. 161-216). New York, N.Y.: Springer.
[28] NextNano software for semiconductor device simulation. http://www.nextnano.com. Accessed 2018.20.01.
[29] T. Wolkenstein. Translated by: E. M. Yankovskii & R. Morrison (1991). Electronic Processes on Semiconductor Surfaces During Chemisorption. New York, N.Y.: Consultants Bureau.
[30] A. Rothschild & Y. Komem (2003). Numerical computation of chemisorption isotherms for device modeling of semiconductor gas sensors. Sens. Actuator B-Chem. 93(1-3), 362-369.
[31] S. Gomri, J.-L. Seguin, J. Guerin, & K. Aguir (2006). Adsorption-desorption noise in gas sensors: Modelling using Langmuir and Wolkenstein models for adsorption. Sens. Actuator B-Chem. 114(1), 451-459.
[32] L. Lugani (2015). “Leakage mechanisms and contact technologies in InAlN/GaN high electron mobility transistors,” EPFL Ph.D. Thesis 6628.
[33] S. M. Sze & K. K. Ng (2007). Semiconductor Devices: Physics and Technology (3rd ed.). Hoboken, N.J.: Wiley Interscience.
[34] L. Kronik and Y. Shapira (1999) Surface photovoltage phenomena: theory, experiment, and applications. Surf. Sci. Prep. 37(1-5), 1-206.
[35] H. C. Gatos & J. Lagowski (1975). Semiconductor sensors. U.S. Pat. No. 4,011,745

The entire contents of each of the above references are herewith incorporated by reference.

1-38. (canceled)

39. Vacuum pressure gauge or gas pressure measurement device comprising:
a polar semiconductor structure;
at least one light source for illuminating a surface of the polar semiconductor structure;
measurement means configured to measure a value representing a gas adsorption rate or a change in gas adsorption rate on the surface of the polar semiconductor structure; and
comparison means configured to compare said measured value with at least one predetermined setpoint value representing a balance between photoinduced desorption and gas adsorption on the surface of the polar semiconductor structure.

40. Vacuum pressure gauge or gas pressure measurement device according to claim 39, further including control means configured to change an optical output power of the light source to match or substantially match said measured value with said setpoint value.

41. Vacuum pressure gauge or gas pressure measurement device according to claim 39, further including:
determination means configured to determine or measure the optical output power or the change in optical output power of the light source at which said measured value matches or substantially matches said setpoint value;
storage means including at least one data set associating, for the at least one predetermined setpoint value, (i) a plurality of pressure values with (ii) optical output power values or changes in optical output power values of the light source; and
calculation means configured to determine a pressure value based on said at least one data set and said measured or determined optical output power of the light source or said measured or determined change in optical output power values of the light source.

42. Vacuum pressure gauge or gas pressure measurement device according to claim 39, wherein the measurement means is configured to measure a value representing a Schottky barrier height of the of the polar semiconductor structure.

43. Vacuum pressure gauge or gas pressure measurement device according to claim 39, wherein
the measurement mean is configured to measure a surface charge value or a sheet resistance value of the polar semiconductor structure;
the comparison means is configured to compare the measured surface charge value or sheet resistance value with at least one predetermined setpoint surface charge value or setpoint sheet resistance value of the polar semiconductor structure;
the control means is configured to change an optical output power of the light source to match or substantially match the measured surface charge value with the at least one setpoint surface charge value or the measured sheet resistance value with the at least one setpoint sheet resistance value;
the determination means is configured to determine or measure the optical output power of the light source at which the measured surface charge value or the measured sheet resistance value matches or substantially matches the at least one setpoint surface charge value or setpoint sheet resistance value; or the change in optical output power of the light source required such that the measured surface charge value or measured sheet resistance value matches or substantially matches the at least one setpoint surface charge value or setpoint sheet resistance value;
the storage means includes at least one data set associating, for the at least one predetermined setpoint surface charge value or setpoint sheet resistance value, (i) a plurality of pressure values with (ii) optical output power values or changes in optical output power values of the light source; and
the calculation means is configured to determine a pressure value based on said at least one data set and said measured or determined optical output power of the light source or said measured or determined change in optical output power values of the light source.

44. Vacuum pressure gauge or gas pressure measurement device according to claim 39, wherein the calculation means is configured to determine a pressure value by determining a pressure value of the at least one data set corresponding to or associated with the measured or determined optical output power or change in optical output power.

45. Vacuum pressure gauge or pressure measurement device according to claim 39, wherein the storage means includes a plurality of predetermined setpoint values, or a plurality of setpoint surface charge values, or a plurality of setpoint sheet resistance values.

46. Vacuum pressure gauge or gas pressure measurement device according to claim 45, wherein the storage means include data associating, for each setpoint value or each predetermined setpoint surface charge values or each setpoint sheet resistance values, (i) a plurality of pressure values with (ii) optical output power values or changes in optical output power values of the light source.

47. Vacuum pressure gauge or gas pressure measurement device according to claim 46, wherein the data comprises a time series dataset.

48. Vacuum pressure gauge or gas pressure measurement device according to claim 39, wherein the at least one light source is configured to emit light to generate photoinduced desorption on the polar semiconductor structure.

49. Vacuum pressure gauge or gas pressure measurement device according to claim 39, wherein the at least one light source is configured to emit light to generate free-carriers in the polar semiconductor structure.

50. Vacuum pressure gauge or gas pressure measurement device according to claim 49, wherein the at least one light source is configured to emit light to generate free-carriers in an external material layer defining a surface upon which photoinduced gas desorption occurs.

51. Vacuum pressure gauge or gas pressure measurement device according to claim 39, wherein the at least one light source is configured to emit light at a photon energy above a band gap energy of an external material layer of the polar semiconductor structure.

52. Vacuum pressure gauge or gas pressure measurement device according to claim 39, wherein the polar semiconductor structure comprises a 2DEG semiconductor structure.

53. Vacuum pressure gauge or gas pressure measurement device according to claim 52, wherein the measurement means is configured to measure a 2DEG sheet resistance value of the polar semiconductor structure.

54. Vacuum pressure gauge or gas pressure measurement device according to claim 39, further including a device comprising the polar semiconductor structure, a thin film heater and/or a suspended gate electrode.

55. Vacuum pressure gauge or gas pressure measurement device according to claim 39, wherein the measuring means includes measuring means configured to measure a sheet resistance value of the polar semiconductor structure via a two-electrode configuration, a three-electrode configuration or a four-electrode configuration.

56. Vacuum pressure gauge or gas pressure measurement device according to claim 39, wherein the data set or sets are included in a look-up table stored in the storage means.

57. Vacuum pressure gauge or gas pressure measurement device according to claim 39, wherein the storage means includes the at least one predetermined setpoint value representing a balance between photoinduced gas desorption and gas adsorption on the surface of the polar semiconductor structure, or the at least one predetermined setpoint surface charge value or setpoint sheet resistance value of the polar semiconductor structure.

58. Vacuum pressure gauge or gas pressure measurement device according to claim 39, wherein the storage means includes a program or processor executable instructions containing instructions allowing to determine a pressure value based on said at least one data set and said measured or determined optical output power of the light source or said measured or determined change in optical output power values of the light source.
